(19) United States
(12) Patent Application Publication
(10) Pub. No.: US 2005/0015933 A1
(43) Pub. Date: Jan. 27, 2005

(54) Removable handles for cooking vessels and cooking vessels using same

(76) Inventor: Tom Hasegawa, Torrance, CA (US)

Correspondence Address: Curtis L. Harrington, Suite 250, 6300 State University Drive, Long Beach, CA, 90815, US

(21) Appl. No.: 10/627,788

(22) Filed: Jul. 25, 2003

(51) Int. Cl. E05B 1/00

(52) U.S. Cl. 16/422

(57) ABSTRACT

A handle system attaches to the side of a cooking vessel and enables the removable handle to be securely fixed to the cooking vessel and to be easily removed when it is not required. Multiple embodiments of the engaged and engagement structures are illustrated and include a rectangular handle bracket and a variety of handle; a variety of rivet heads and shafts and a variety of rivet engaging tong structures, along with a variety of mechanisms for operating all of the engagement and disengagement functions of the above.

### BACKGROUND OF THE INVENTION

The present invention relates to cooking vessels, such as pots or pans and the like, and more specifically, to a cooking vessel with one or more removable handles.

The construction, packaging and transport of cooking vessels are significantly complicated by permanent handle extensions. Handle extensions promote packaging and shipping inefficiency from not being able to stack vessels efficiently and in the creation of dead space around the protruding handle. In a mature industry, such inefficiencies create significant sources of cost.

These increased manufacturing costs of packaging and shipping are multiplied at the retail level in terms of increased uptake of inventory storage. After sale, these space problems continue with the cooking vessels' ultimate consumers.

When putting away cooking vessels, such as pots and pans for storage, one of the most annoying aspects is not only that the cooking vessel handles take up much of the precious space in kitchen cabinets, but also they interfere with attempts to neatly and stably stack them. The handles particularly interfere with the ability to nestle a smaller vessel in a larger one. This problem is particularly acute where living space is limited and where storage space is unavailable.

In order to solve these problems with cooking vessels, it would seem that one of the most effective ways is to make the handle removable. However, removability alone will not suffice. Safety is an important issue, and the removability of any handle must be surpassed by its safety and security of connection. In other words, a mechanism used for handle attachment must not fail during use.

Removable handles currently marketed are of the type where the handle is not very securely attached to the rim of a cooking vessel. The handle is merely clamped on to the rim of a cooking vessel, which is unsafe, breaks the evenness of the rim line of the cooking vessel, and can inhibit the even more sealable placement of lids. Rim attachment is inherently unstable and places significant holding forces over a narrow area of the rim. Rim attachment requires pressure grasping or some variable mechanical method which is more prone to failure.

What is therefore needed is a system for detachable handles which is safe, secure and easy to use. The system should permit and even enhance stacking and handle storage. The handle, once attached, should be as secure as a permanently attached.

### SUMMARY OF THE INVENTION

The handle system attaches to the side of a cooking vessel and enables the removable handle to be securely fixed to the cooking vessel and to be easily removed when it is not required. Several embodiments are disclosed. In one embodiment, a rectangular handle bracket is mechanically (screwing, riveting) or physicochemically (welding) attached to the side of a cooking vessel. The bracket is generally horizontally oriented with respect to the wall of the cooking vessel so that a vertical opening, which may be rectangle-shaped, is formed with the sides of the bracket and the surface of the wall. The interfitting removable handle has a hook on one end, which may be tilted or V-shaped. The removable handle also includes a separate press-down plate. This preferably V-shaped hook is inserted upward into the bracket hole from the bottom side of the bracket, with the press-down plate being placed against the upper edge of the bracket and top of the V-shaped hook. These two components of the removable handle stay together with the use of a circular clip attached to the other end of the V-shaped hook. The other end of press-down plate slides in with a sleeve which slides onto the other ends of the V-shaped hook and the press-down plate, the removable handle is securely attached to the cooking vessel. This combination of a rectangle handle bracket and a removable handle with a hook, and especially with a tilted-V-shaped hook shall be hereafter referred to as “V-Hook Handle.”

The system described cooperates with the preference presently of selling cooking vessels as a pre-assorted set with pots and pans of different sizes. Cooking vessels will be able to take less storage space and will be able to be stacked neatly and in a stable manner. Further, the system enables smaller packaging used to save very precious point-of-sale space for retailers and ever-increasing freight costs for distributors.

The objective of the present invention is to provide an easy-to-store cooking vessel by incorporating a removable handle(s) so that the handle(s) can be removed, and multiple cooking vessels may be neatly and stably stacked up or nestled in one other. The bracket anchoring device may be a set of two rivet-like structures. These rivets are mechanically attached to the side of a cooking vessel and horizontally aligned. These rivets are shaped and attached to the wall of the cooking vessel in such a way so that the exterior (outside of the vessel) portion of each of the rivets has a riser portion and a head portion which diameter is larger than that of the riser portion. A removable handle for this type of anchoring device is tong-shaped with a slotted end piece attached at an angle of approximately 90 degrees on each arm's end. By sliding each end piece of the tong-shaped handle into the space between the wall of the cooking vessel and the underside of rivet head and fitting the riser portion of the rivet into the slot of the end piece, the removable handle is attached to the cooking vessel.

This combination of a set of rivets and a removable tong-shaped handle shall be hereafter referred to as “Tong Handle.” Furthermore, the idea of removable Tong Handle may be applied to the lid of a cooking vessel in order to facilitate easier storage and to save storage space.

### BRIEF DESCRIPTION OF THE DRAWINGS

The invention, its configuration, construction, and operation will be best further described in the following detailed description, taken in conjunction with the accompanying drawings in which:

FIG. 1 shows a section of a cooking vessel with a rectangle bracket attached;

FIG. 2 shows a top view of the bracket of FIG. 1 and further details on the manner of connection of the rectangle bracket to a partially shown wall of a cooking vessel;

FIG. 3 shows a top view of a complete cooking vessel having two brackets;

FIG. 4 shows a perspective view of a v-Hook Handle with its two components, V-shaped hook with a circular clip and press-down plate;

FIG. 5 shows a side view of the v-hook handle of FIG. 4;

FIG. 6 shows a perspective view of a v-Hook Handle with a v-hook which is more shallow;

FIG. 6 shows a perspective view of a v-Hook Handle having its press-down plate removed;

FIG. 7 shows a perspective view of a v-Hook Handle with press-down plate having a curved end;

FIG. 8 shows a perspective view of a v-Hook Handle with a v-hook which will engage a bracket with both its front wall and press-down plate;

FIG. 9 shows a perspective view of a v-Hook Handle engaging a cooking vessel;

FIG. 10 is a schematic view showing the engagement of the v-hook handle of FIGS. 4 and 6 onto a bracket;

FIG. 11 is a schematic view showing the engagement of the v-hook handle of FIG. 8 onto a bracket;

FIG. 12 is a perspective view of a v-Hook Handle secured with a slide on sleeve;

FIG. 13 is a perspective view of a v-Hook Handle having a curved press-down plate secured with a slide on sleeve;

FIG. 14 is a side view of a v-Hook Handle of FIG. 13 and secured with a slide on sleeve;

FIG. 15 is a perspective view of a v-Hook Handle with curved press down plate which will engage a bracket with both its front wall and secured with a slide on sleeve;

FIG. 16 is a perspective view of the v-Hook Handle of FIG. 12 engaged onto a bracket of a cooking vessel

FIG. 17 illustrates a perspective view of a pair of rivets mounted on a cooking vessel wall;

FIG. 18 is a top view of a cooking vessel of FIG. 17;

FIG. 19 is an expanded perspective view of a curved head, square shaft rivet;

FIG. 20 is an expanded perspective view of a plate shaped head rectangular cross sectionally shaped shaft rivet;

FIG. 21 is an expanded perspective view of a round head cylindrically shaft rivet;

FIG. 22 is an expanded perspective view of a plate shaped head and rectangular cross sectionally shaped shaft rivet;

FIG. 23 is a partial sectional view of a tong shaped load member having a square slot;

FIG. 24 is a perspective view of the tong shaped load member of FIG. 23;

FIG. 25 is a partial sectional view of a tong shaped load member having a rounded end slot;

FIG. 26 is a perspective view of the tong shaped load member of FIG. 25;

FIG. 27 is a view of a pair of tong shaped load members engaging a cooking vessel having rivets by movement of the tong shaped load members toward each other;

FIG. 28 is a view of a pair of tong shaped load members engaging a cooking vessel having rivets by movement of the tong shaped load members away from each other;

FIG. 29 is a perspective view of a pair of vertically oriented brackets which define horizontal, generally rectangular shaped through holes;

FIG. 30 is a top view of cooking vessel seen in FIG. 29;

FIG. 31 is a partial sectional view of an “E” shaped plate of a tong shaped load member;

FIG. 32 is a perspective view of the “E” shaped plate of a tong shaped load member of FIG. 31;

FIG. 33 is a partial sectional-view of an “E” shaped plate of a tong shaped load member;

FIG. 34 is a perspective view of the “E” shaped plate of a tong shaped load member of FIG. 33;

FIG. 35 is a perspective view of the “E” shaped plates of a pair of tong shaped load members oriented toward each other and engaging the vertical brackets seen in FIG. 29 on a cooking vessel;

FIG. 36 is a perspective view of the “E” shaped plates of a pair of tong shaped load members oriented away from each other and engaging the vertical brackets seen in FIG. 29 on a cooking vessel;

FIG. 37 is a perspective view of an overall tong handle having a tie brace;

FIG. 38 is a perspective view of an overall tong handle having a linking brace;

FIG. 39 is an exploded view of the linking brace of FIG. 38;

FIG. 40 is an assembled view of the overall tong handle of FIG. 38 engaging rivets of a cooking vessel;

FIG. 41 is a partially exploded perspective view of a handle assembly which includes a pair of tong members directed away from each other and captured in an engagement sleeve;

FIG. 42 is a partially exploded perspective view of a handle assembly which includes a pair of tong members directed toward each other and captured in an engagement sleeve;

FIG. 43 is an assembled handle assembly seen in FIG. 42;

FIG. 44 is a partially exploded perspective view of a handle assembly which includes a pair of tong members directed away from each other and captured in a grip guide having a guide slot;

FIG. 45 is a partially exploded perspective view of a handle assembly which includes a pair of tong members directed toward each other and captured in a grip guide having a guide slot;

FIG. 46 is an assembled handle assembly seen in FIG. 45;

FIG. 47 is a sectional side view of a lid;

FIG. 48 is a top view of the lid of FIG. 47;

FIG. 49 is a view of the ends of opposing handle members having curve ended slots, about a round rivet shaft;

FIG. 50 is a view of the ends of opposing handle members having square ended slots, about a square rivet shaft;

FIG. 51 is a view of the ends of opposing handle members having curve ended slots, about an oval rivet shaft;

FIG. 52 is a view of the ends of opposing handle members having square ended slots, about a rectangular rivet shaft;

FIG. 53 is an exploded view of the handle assembly of FIG. 49 along with illustration of a tray and grip insert for securing the handle assembly;

FIG. 54 is a side view of the assembled handle assembly shown in FIG. 53;

FIG. 55 is a partial sectional view of a lid having a single rivet;

FIG. 56 is a top view of the lid of FIG. 55;

FIG. 57 is a perspective view of a oval shaped handle mounted atop the lid of FIGS. 55 and 56, the handle using overlapping hook members;

FIG. 58 is a closeup view of the oval shaped handle of FIG. 57;

FIG. 59 is a closeup view of the oval handle oppositely oriented overlapping hook members seen oppositely engaging a rectangular rivet shaft;

FIG. 60 is a closeup view of the oval handle oppositely oriented overlapping hook members seen oppositely engaging a square rivet shaft; and

FIG. 61 is a closeup view of the oval handle oppositely oriented overlapping hook members seen oppositely engaging an oval rivet shaft.

### DETAILED DESCRIPTION OF THE INVENTION

The removable handle mechanism of the present invention consists of two main components, a removable handle and an anchoring device for the removable handle. There are two types of removable handle disclosed. The first is a handle with a v-shaped hook at one end and the second is a tong-shaped handle. The handle with a v-shaped hook at one end shall be referred to as “v-hook handle” hereafter and the tong-shaped handle shall be referred to as “tong handle”. Each type of these removable handles is associated with a different type of handle anchoring device. The following is a brief description of each type of removable handle and its anchoring device.

Throughout all of the structures shown, interfitting of parts may be assisted by a magnetic property of the materials, or in the alternative, they may be interference fit or other manner of making a stable assembly. Some of the potential geometry and magnetic orientation of the materials may be mentioned, but the specific magnet polarity arrangement may vary widely from structure to structure. Further, it is understood that heat can have a deliterious effect on magnetic materials and it will generally be preferable to locate the holding force and magnetic field polar focus to locations as much removed from the heat source as is possible.

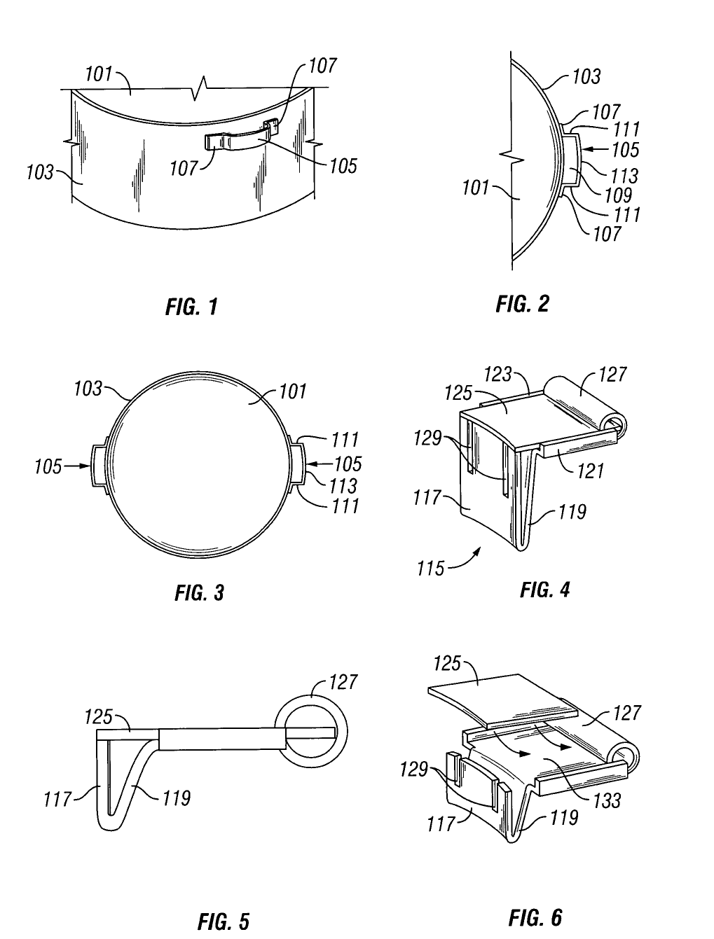

Referring to FIG. 1, a perspective view of a portion of a cooking vessel 101 shows a side wall 103 and a bracket 105. Bracket 105 is generally expected to be rectangular in order to leave a thinner space in terms of distance between the side wall 103 and the center of the bracket 105. The bracket 105 may be attached to the side wall 105 through a pair of oppositely oriented footing members 107 which are oriented generally parallel or following the outer surface of the side wall 103. Footing members 107 may be attached to the side wall 105 by welding, bolting, riveting, screwing, or other safe, secure method.

Referring to FIG. 2, a top view of the portion of cooking vessel 101 illustrates a somewhat rectangular shaped through hole 109. The component parts of the bracket 105 are seen to be a pair of riser sections 111, each located adjacent the turning corner of the bracket footings 107. The riser sections 111 angle sharply toward each other and a main portion 113 of the bracket 105 is identified.

The width of the through hole 109 is defined by the space between the cooking vessel wall 103 and main portion 113 of the bracket 105. The shape of the through hole 109 will be narrower at the center of the main portion 113 for cooking vessels 101 with more sharply curved walls.

Referring to FIG. 3, a view of two sides of a cooking vessel 101 is seen as fitted with a pair of brackets 105.

Referring to FIG. 4, a side perspective view of a v-hook handle member 115 is seen, with the name referring to the lateral shape. A front wall 117 is sharply angled with respect to a rear wall 119 to form a “v” hook shape from a lateral perspective. The angle of the front wall 117 may have an angle with respect to the rear wall 119 to form a friction fit with respect to the structures surrounding the somewhat rectangular shaped through hole 109. A raised side edge 121 and a raised side edge 123 are seen, and a press-down plate 125 is seen between the side edges 121 and 123. A circular clip 127 is seen at the far end of the v-hook handle.

A pair of slots 129 are seen in the front wall 117. The slots 129 are upwardly directed and may be cut or formed. The two slots 129 are shaped in such a way that each slot accepts the corresponding riser section 111 of the bracket 105. The v-hook handle 115 circular clip 127 is attached or formed with the end of the v-hook handle 115 farthest away from the cooking vessel 103. The press-down plate 125 is a separate structure. Either the press-down plate 125 may be made magnetic especially to engage the top of the front wall 117 as well as the structure underlying the press-down plate 125. The circular clip structure 127 may serve to hold down and cover the other end of the press-down plate 125. In the alternative, raised side edges 121 and 123 could be oppositely magnetically polarized to trap the press-down plate 125.

Referring to FIG. 5, a side view of the v-hook handle member 115 is shown.

Referring to FIG. 6, a further embodiment of a variation on the v-hook handle member 115 is seen as a v-hook handle member 131 having a more shallow “v” shape. The press-down plate 125 is shown in lifted position to expose an underlying horizontal planar member 133 which supports the pair of opposing side edges 121 and 123.

As an alternative magnetic arrangement, the press-down plate 125 can be vertically magnetically polarized, as can the underlying horizintal planar member 133. However, mechanical structure for facilitating connectivity is also possible.

As can be seen the pair of opposing side edges 121 and 123 can act at minimum as a guide for the placement of the press-down plate 125 and can have surface modifications including snap interference surfaces and more. The circular clip 127 is designed in a way so that it allows the press-down plate 125 to slide snugly into its opening defined by raised side edges 121 and 123 and underlying planar member 133.

The v-hook meeting shape of the front wall 117 and rear wall 119 is shaped in a way so that when its front wall 117 is applied to the side wall 103 of the cooking vessel 101, the open end front wall 117 lies nearly flat to perfectly flat against the side wall 103. Of course, different curvature cooking vessels 101 will have different curvature side walls 103, and there is no particular restriction that a given v-hook handle 115 can be only applied to one corresponding cooking vessel 101.

When the front wall 117 of the v-hook handle member 115 or 131 is inserted upward into the bracket hole 109, the press-down plate 125 is placed on top of the underlying planar member 133. Also, the end of the press down plate 125 is inserted into the opening of the circular clip 127. When the handle of the v-hook handle 115, 131 presses down on the upper edge of the bracket 105, the v-hook handle 115, 131 is securely attached to the wall 103 of the cooking vessel 101.

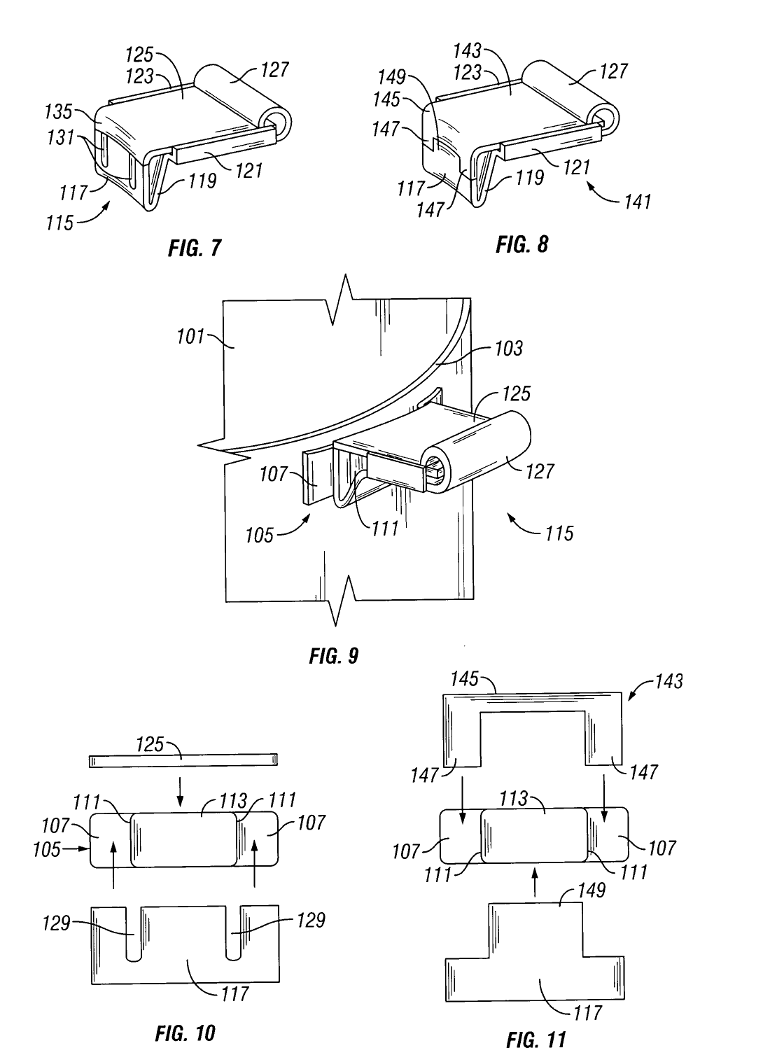

Referring to FIG. 7, a variation on the v-hook handle member 115 is seen as a v-hook handle member 131 where the press-down plate 125 has a curved end 135 which extends downward to meet the upper edge of the front wall 117. Magnetic structure may be expected to be employed in all of the remaining embodiments in a manner which may be similar to or different from that described for FIGS. 4-6.

Referring to FIG. 8, a further variation on the v-hook handle members 115 and 131 is seen as a v-hook handle member 141, which has a press-down plate 143 having a curved forward end 145 which is somewhat complementarily shaped with respect to the structure below it. The curved forward end 145 may have a deeper fitting extent, and is shown as having a pair of downwardly extending side projections 147 which are complementary to a centered upward projection 149. A vertical gap is preferably had between the downwardly extending side projections 147 and the centered upward projection 149 where it is desired to engage the inside and outside of the bracket 105. The other details of the v-hook handle member 141 are the same as for v-hook handle members 115 and 131. If it is desired only to engage the inside of the bracket 105, the width of the front wall 117 could be expected to be narrower to enable the front wall 117 to fit more completely within the rectangular shaped through hole 109, preferably closely fitting against the inside of the footing members 107. The v-hook handle members 115, 131, and 141 may be altered to suit an individual applications.

Referring to FIG. 9, a perspective view of the attachment of the v-hook handle members 115 to the cooking vessel 101 by engagement with the bracket 105 is shown. In terms of the action of attachment, with the press-down plate removed, the front wall 117 is positioned adjacent the side wall 103 directly underneath the bracket 105 in a position where the two slots 129 of the front wall 117 are directly underneath riser sections 111.

Referring to FIG. 10, this is somewhat schematically illustrated with the side wall 103 eliminated for clarity of illustration. The front wall 117 is shown underneath the bracket 105, while the press-down plate 125 is shown above, as having been removed. Upward movement of the front wall 117 through the inside rectangular shaped through hole 109 and outside of the rectangular shaped through hole 109, combined with downward implacement of the press-down plate 125 will form the structure seen in FIG. 9.

Referring to FIG. 11, a view similar to that seen in FIG. 10 illustrates front wall 117 of v-hook handle member 141. As shown, the curved forward end 145 of the press-down plate 143 is shown with the pair of downwardly extending side projections 147 which are sized to fit to the outside of the riser sections 111. The centered upward projection 149 fits within the rectangular shaped through hole 109. Thus, the v-hook handle member 141 “bites” or engages bracket 105 on its inside and outside.

In terms of providing a structure to hold down the press down plates 125 and 143 it is noted that the positioning and choice of materials for the circular clip 127 can assist in holding press down plates 125 and 143 down. In addition, the use of magnetic materials can also aid this effort. The bracket 105, press down plates 125 and 143, underlying planar member 133, or raised side edges 121 and 123 can each have magnetic materials of the proper polarization to form a secured interfitted relationship.

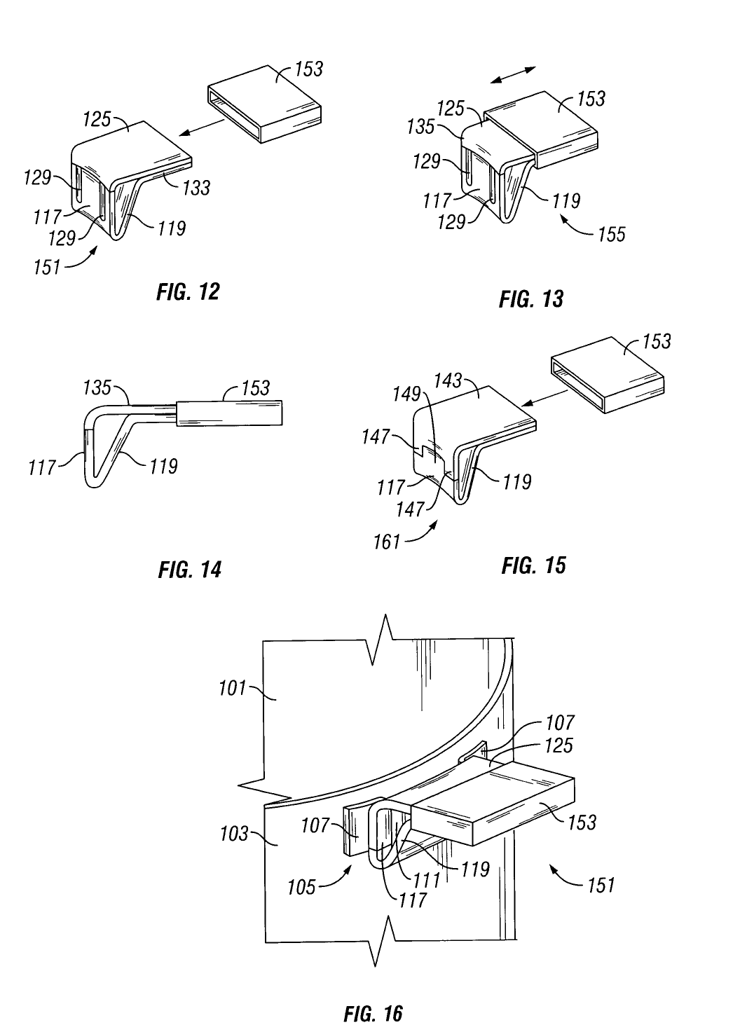

Referring to FIG. 12, a different holding and securing arrangement is shown. A v-hook handle member 151 uses a slide on holder sleeve 153 to secure press-down plate 125 onto the top of an underlying planar member 133 instead of the circular clip 127 which is shown attached to the v-hook 115.

Underlying planar member 133 is the same as was seen for v-hook handle member 115, but the raised side edges 121 and 123 are removed and the holder sleeve not only holds the press-down plate 125 into position over the top of the front wall 117, but also gives it the lateral stability and centeredness over the underlying planar member 133. The holder sleeve 153 can be elastomeric or metal and may be stressed to put force pressure onto the stacked press-down plate 125 and underlying planar member 133.

Referring to FIG. 13 a v-hook handle member 155 uses the slide on holder sleeve 153 to secure the press-down plate 125 having a curved end 145, with respect to the top of the front wall 117 and the upper surface of the planar member 133. The view of FIG. 13 shows an assembled v-hook handle member 155. Referring to FIG. 14, a side view of the v-hook handle member 155 seen in FIG. 13 is shown.

Referring to FIG. 15, an exploded view of v-hook handle member 161 includes the press-down plate 143 with downward projections 147 opposing a front wall 117 having a centered upward projection 149 is shown.

Referring to FIG. 16, a perspective view of the attachment of the v-hook handle member 151 to the cooking vessel 101 by engagement with the bracket 105 is shown. The v-hook handle member 151 is attached to a handle anchoring device bracket 105, which is permanently attached to the exterior wall 103 of the cooking vessel 101. Again, the bracket 105 is a rectangle bracket permanently attached at its footing members 107 which extend outward by means of screwing, bolting, riveting or welding on the wall 103 of the cooking vessel 101.

The vertical rectangular shaped through hole 109 formed with the three sides of the bracket 105 and the wall 103 of the cooking vessel 101 is sized and shaped to snugly accommodate the end wall 117 of the v-hook handle 151 when it is inserted upward into the rectangular shaped through hole 109 from the bottom side of the bracket 105. The slide-on sleeve 153 is preferably box-shaped with an open side. When the press-down plate 125 is placed on top of the underlying planar member 133 and the slide on holder sleeve 153 slid over the underlying planar member 133 and press-down plate 125, v-hook handle member 151 will become secured onto the wall 103 of the cooking vessel 101 as shown in FIG. 16. The design of the front wall 117 and the press down plate 125 or 135 may be altered to suit any individual application. The slide-on sleeve 153 is shown as being box-shaped. However, the shape of the slide-on sleeve may be altered to improve its ergonomic and aesthetic qualities.

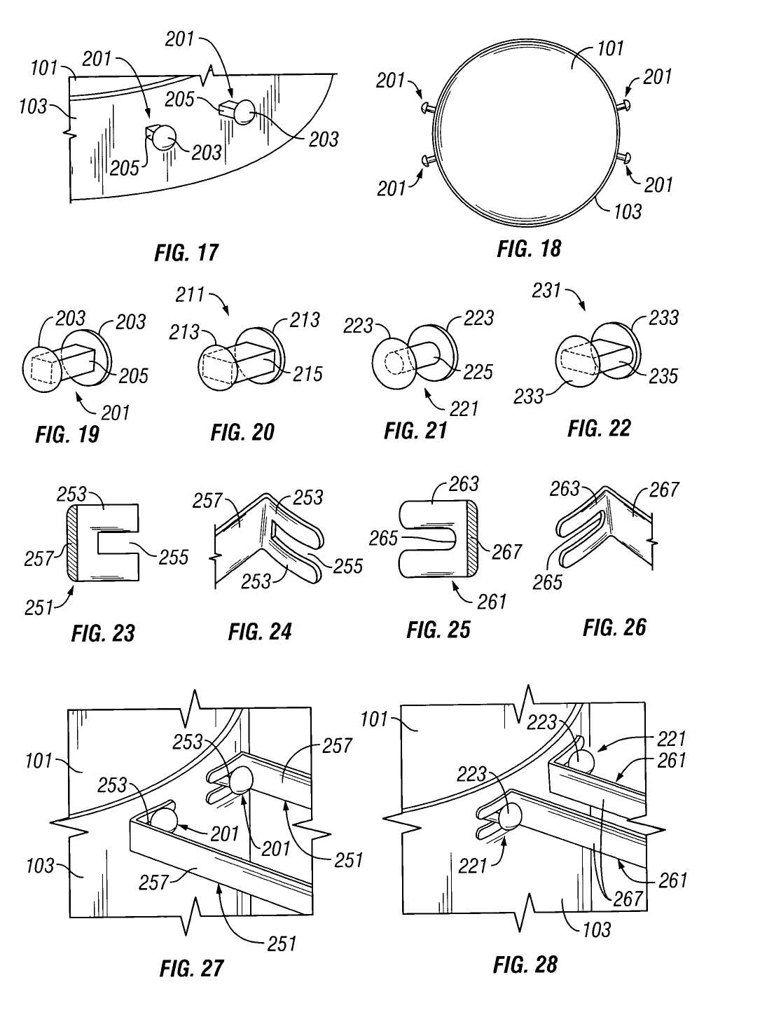

Referring to FIG. 17, a beginning of an explanation of a tong handle system is presented. A cooking vessel 101 side wall 103 has a pair of stand out rivets 201. Rather than include insertion up to the heads 203, the rivets 201 are stood off from the surface of the side wall 103 to expose a length of the shafts 205 of the rivets 201.

Referring to FIG. 18, a top view of cooking vessel 101 illustrates the positions of the rivets 201 on a cooking vessel 101 having two pairs of such rivets 201. For stacking, the rivets 201 should be located close to the top of cooking vessels 101 with the height of each additional stacked cooking vessel adding a dimension between the rivets 201 and the top of the cooking vessel 101.

Several rivet shapes are possible, with the shape of rivets 201 shown as having spherical heads 203 and a rectangular shaft 205.

Referring to FIG. 19 an expanded perspective view of rivet 201 and illustrating the curved head 203 and square shaft 205. As shown in FIG. 19, the rivet 201 may have one head 203 larger than the other, typically with an internal (inside side wall 103) head (typically smaller) being closely conforming to the side wall 103. The exterior head 205 seen in FIG. 17 is typically large to enable significant torsional and pulling forces to be supported.

Referring to FIG. 20, a rivet 211 having a pair of plate shaped heads 213 and a rectangular cross shaped shaft 215 is shown. The use of a rectangular cross sectional shaped shaft 215 can enable more significant torsional load in one direction than another.

Referring to FIG. 21, a rivet 221 having a pair of rounded heads 223 and a cylindrical cross sectional shaped shaft 225 is shown. The use of a cylindrical shaft 225 can enable more load spreading and controlled wear due to elimination of edges.

Referring to FIG. 22, a rivet 231 having a pair of plate heads 233 and a rectangular cross sectional shape shaft 235 is shown. The use of a rectangular cross sectional shaped shaft 235 can enable a tighter tolerance head 233 engagement and more controlled torsion.

Referring to FIG. 23, a tong shaped load member 251 includes an overall “U” shaped plate 253 having a square slot 255. Overall “U” shaped plate 253 is at right angles to a main length 257 which would normally extend from the paper.

Referring to FIG. 24, a perspective view of the extent of the tong shaped load member 251 illustrates that the overall “U” shaped plate 253 may be curved and may be angled with respect to the main length 257.

Similar to FIG. 23, and Referring to FIG. 25, a tong shaped load member 261 includes an overall “U” shaped plate 263 having a rounded slot 265. Overall “U” shaped plate 263 is at right angles to a main length 267 which would normally extend from the paper.

Referring to FIG. 26, a perspective view of the extent of the tong shaped load member 261 illustrates that the overall “U” shaped plate 263 may be curved and may be angled with respect to the main length 267.

Referring to FIG. 27, tong shaped load member 251 is shown engaging rivets 201 extending from a side wall 103 of a cooking vessel 101, in order to show the manner of engagement of the tong shaped load member 251 to lift the cooking vessel 101.

Referring to FIG. 28, tong shaped load member 261 is shown engaging rivets 221 extending from a side wall 103 of a cooking vessel 101, in order to show the manner of engagement of the tong shaped load member 261 to lift the cooking vessel 101.

In terms of interfit and use, the “U” shaped plate 253 and 263 has a slots 255 and 265 formed in them. The, “U” shaped plate 253 and 263 is preferably slightly curved so that when it is applied to the exterior surface of the wall 103 of the cooking vessel 101, it can lie flat to eliminate an otherwise gap between the “U” shaped plate 253 and 263 and the surface of the wall 103. The tong shaped load members 251 and 261 are made of metal or heat-resistant hard plastic and made flexible enough or are mechanically joined so that the tong shaped load members 251 and 261 can be squeezed closer, decreasing their relative distance or spread wider, increasing the distance between each other.

As has been shown, the anchoring device for the tong shaped load member 251 and 261 are rivets 201 attached to the wall 103 of a cooking vessel 101, and they are shown horizontally aligned. One of the heads of each rivet 201 rests against the interior surface of the wall 103 of the cooking vessel 101. The exposed shaft 205, 215, 225, or 235 of the rivet 201, 211, 221, or 231 acts as a riser and its cross sectional size is such as to enable tong shaped load members 251 and 261, by their “U” shaped plate 253 and 263, to be firmly fixed against the exterior wall 103 of the cooking vessel 101.

As with all rivets in this description and throughout the specification, the head of each rivet is larger in at least one dimension to allow the rivet to be mechanically engaged. Generally, the height of the exposed shaft beyond the exterior surface of the wall 103 of the cooking vessel 101 is equal to or slightly larger than the thickness of the “U” shaped plate 253 and 263 so that it allows the “U” shaped plate 253 and 263 slip into the space between the exterior surface of the wall 103 of the cooking vessel 101 and the bottom of the rivet head 203, 213, 223, and 233.

Squeezing the arms of the tong shaped load member 251 or tong shaped load member 261 261 together allows them to be placed between (or outside of and embracing) the two rivets, 201 for example, on the wall 103 of the cooking vessel 101, aligning the slots 255 or 265 the shafts 205, 215, 225, 235.

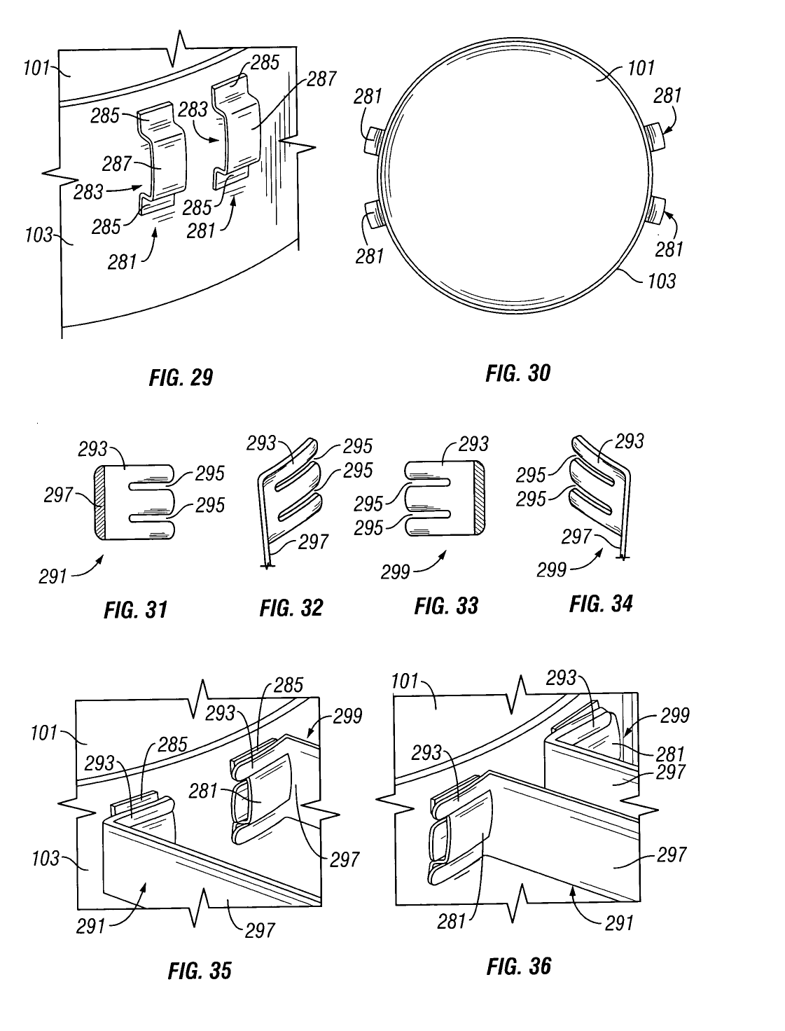

Referring to FIG. 29, a beginning of an explanation of an alternative version of a tong handle system is presented. A cooking vessel 101 side wall 103 has a pair of vertically oriented brackets 281 which define horizontal, generally rectangular shaped through holes 283. The pair of vertically oriented brackets 281 each have a pair of footing members 285 and a main portion 287.

Referring to FIG. 30, a top view of cooking vessel 101 illustrates the positions of the pair of vertically oriented brackets 281 on a cooking vessel 101 having two pairs of such pair of vertically oriented brackets 281. For stacking, the pair of vertically oriented brackets 281 should be located close to the top of cooking vessels 101 with the height of each additional stacked cooking vessel adding a dimension between the pair of vertically oriented brackets 281 and the top of the cooking vessel 101. Again slight variation in the shape of the pair of vertically oriented brackets 281 are possible.

Referring to FIG. 31, a tong shaped load member 291 includes an overall “E” shaped plate 293 having a pair of narrow, rounded slots 295. Overall “E” shaped plate 293 is at right angles to a main length 297 which would normally extend from the paper.

Referring to FIG. 32, a perspective view of the extent of the tong shaped load member 291 illustrates that the overall “E” shaped plate 293 may be curved and may be angled to one side with respect to the main length 297.

Similar to FIGS. 31 and 32, and Referring to FIGS. 33 and 34, a tong shaped load member 299 is of opposite orientation than the tong shaped load member 291, but otherwise has the same structures as tong shaped member 291.

Referring to FIG. 35, a pair of tong shaped load members 291 and 299 are shown engaging pair of vertically oriented brackets 281 with each of the tong shaped load members 291 and 299 opposing each other with the slots 295 of the tong shaped load members 291 and 299 in an opposing relationship. In the orientation of FIG. 35, the middle portions of the plates 293 engage the vertically oriented brackets 281 by moving toward each other.

Referring to FIG. 36, the pair of tong-shaped load members 291 and 299 are shown engaging pair of vertically oriented brackets 281 with each of the tong shaped load members 291 and 299 opposing each other with the slots 295 of the tong shaped load members 291 and 299 facing away from each other. In the orientation of FIG. 36, the middle portions of the plates 293 engage the vertically oriented brackets 281 by moving away from each other.

In order to facilitate moveable placement of members, followed by fixation of placement of the members heretofore described, some locking into a desired attached state is preferable. A secure sliding lock, fitting, ring lock, or other structure which prevents disengagement can work well with any structure to maintain its locked position.

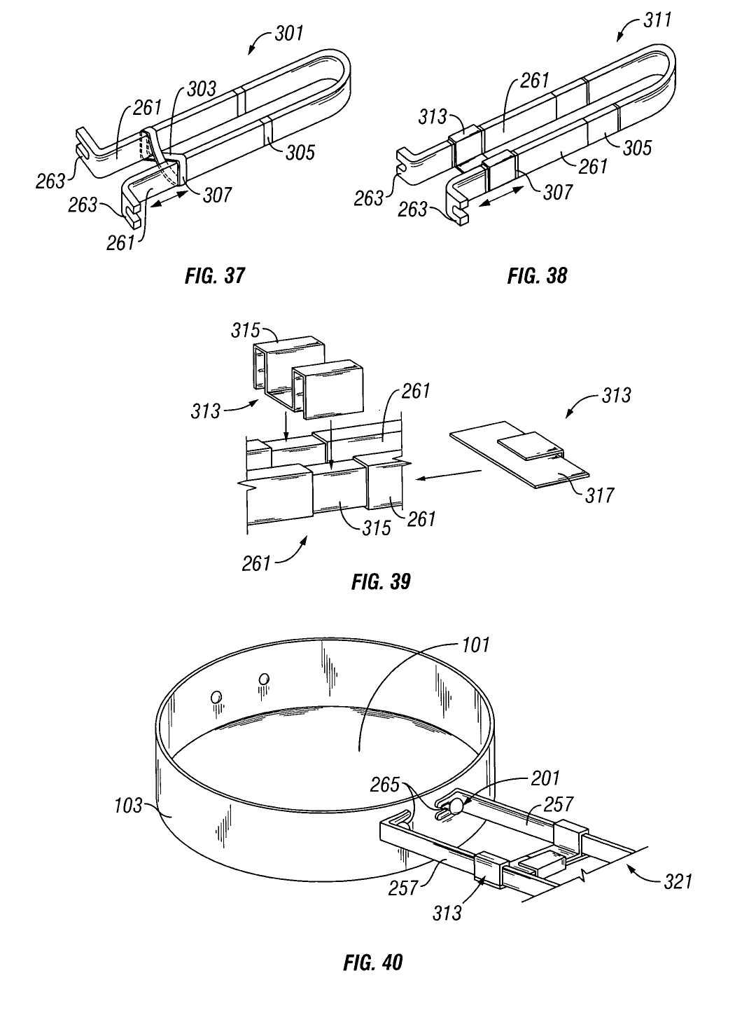

Referring to FIG. 37 a complete tong handle 301 includes a pair of connected tong shaped load members 261. A tie brace 303 is shown as being moved from a rearward resting position 305 to a forward resting position 307. Now especially where the tie brace 303 is non-rigid, the tong handle 310 may be formed to naturally spring wide apart without any tie brace 303. In this case, moving the tie brace 303 to the rearward position 305 would insure that the tong shaped load members 261 untrammel their natural spring force to use spring force to engage rivets 201, 211, 221, or 231. The forward movement of the tie brace 303 to the position 307 will exert inward displacement force enough to enable disengagement of the rivets 201, 211, 221, or 231. Rearward resting position 305 and forward resting position 307 may typically be indented portions of the overall tong handle 301.

The tie brace 303 may be of one piece construction, or may be a once-twisted ring, forming two rigid separated ringlets. Each ringlet of the tie brace 33 encircles one of the arms of the tong shaped load member 251.

By sliding the tie brace 303 along the arms of the tong shaped load member 251, or 261, the relative movement of the engagement ends toward or away from each other is restricted and controlled, to a position of either spreading them further apart or bringing them closer together. The tong shaped load members 251 and 261 can be spring biased toward or away from each other with tie brace 303 working with or against the direction of spring urging. Rearward resting position 305 and forward resting position 307 can be established physically by forming a set of two grooves or other physical structure which promotes stability at either of the two positions 305 and 307. Generally, where the spring bias is set to move the tong shaped load members 261 away from each other, the rearward resting position 305 will enable manipulation of the “U” shaped plates 263 into a locked position, while forward resting position 307 will enabled the “U” shaped plates 263 into an un-locked position.

Referring to FIG. 38 a complete tong handle 311 includes a pair of connected tong shaped load members 261. A linking brace 313 is shown as being moved from a rearward resting position 305 to a forward resting position 307 to insure that the tong shaped load members 261 remain urged away from each other after they engage the rivets 201, 211, 221, or 231. Rearward resting position 305 and forward resting position 307 may typically be indented portions of the overall tong handle 301.

Linking brace 313 is shown to be a bracket-type device which is snapped onto the arms of the tong shaped load members 261 and slid along their length, increasing or decreasing the distance between the two tong shaped load member 251 or 261. Again, grooves or other physical structures may be present to give effect to the rearward resting position 305 and forward resting position 307. Again, the load members 261 may be spring biased to either position, but preferably toward a locking position.

Referring to FIG. 39, an exploded view of the linking brace 313 having a top plate 315 which is shown to be of an inverted “W” shape, and a bottom plate 317. The forward resting position 261 is seen as an indentation section 315.

Referring to FIG. 40, an overall view similar to that of FIG. 27 illustrates a complete view of the cooking vessel 101 having a connected tong handle 321 in which the tong shaped load members 261 are oriented so that the main lengths 267 are oriented such that the rounded slots 265 face each other and in which the linking brace 313 is engaged to keep the rounded slots 265 engaged onto the rivets 201.

In FIGS. 37 and 39, the complete tong handle 301 and 311 were seen as having an elongated letter “U” shape. However, a support structure may be designed to be shorter and more square-shaped, and utilize a square relationship so that, for example, two support structures join or are supported at right angles. The shortness of support structure will inhibit flexibility and make more difficult any sliding brace locking structure. However this problem is addressed by providing a fixation groove in other more specialized structure to hold support structures into an engagement position.

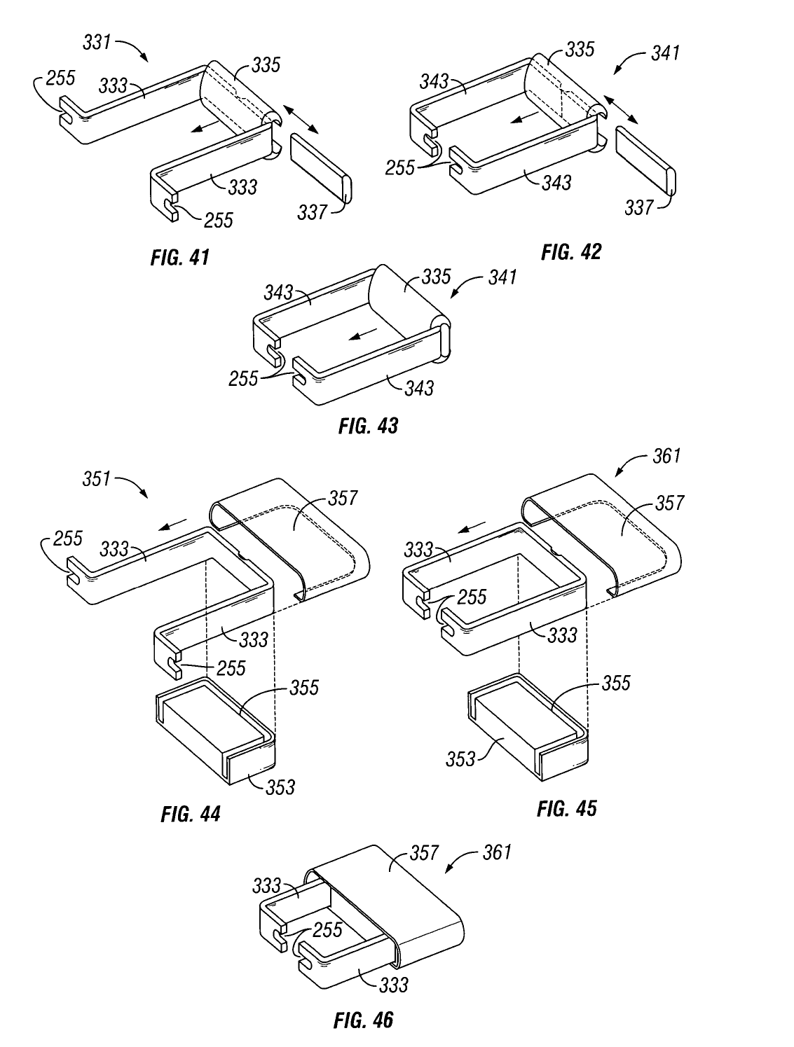

Referring to FIG. 41, a handle assembly 331 includes a pair of tong members 333 having oppositely directed slots 255 and which are captured in an engagement sleeve 335 and secured by a slidable cover member 337.

Referring to FIG. 42, a variation is seen as a handle assembly 341 includes a pair of tong members 343 having opposing slots 255 and which are again captured in an engagement sleeve 335 and secured by the same slidable cover member 337. FIG. 43 illustrates the handle assembly 341 in completely assembled position. In FIGS. 41 and 42, the tong members 333 and 343 may be connected to each other or integrally formed.

Referring to FIG. 45, a further variation is seen as a handle assembly 351 which includes a pair of tong members 333 having opposing slots 255 and which are captured in a handle grip guide 353 having a guide slot 355. Once the grip guide 353 is fitted under the tong members 333 such that the tong members 333 fit closely within the guide slot 355. To secure the engagement, a curved grip mold cover 357 snaps around the handle grip guide 353 tong members 333 assembly.

Referring to FIG. 45 a further variation is seen as a handle assembly 351 which includes a pair of tong members 333 having opposing slots 255 and which are again captured in handle grip guide 353 having a guide slot 355 and covered with curved grip mold cover 357.

Referring to FIG. 46, handle assembly 361 is shown in assembled condition. Again in FIGS. 44 and 45, the tong members 333 and 343 may be connected to each other or integrally formed.

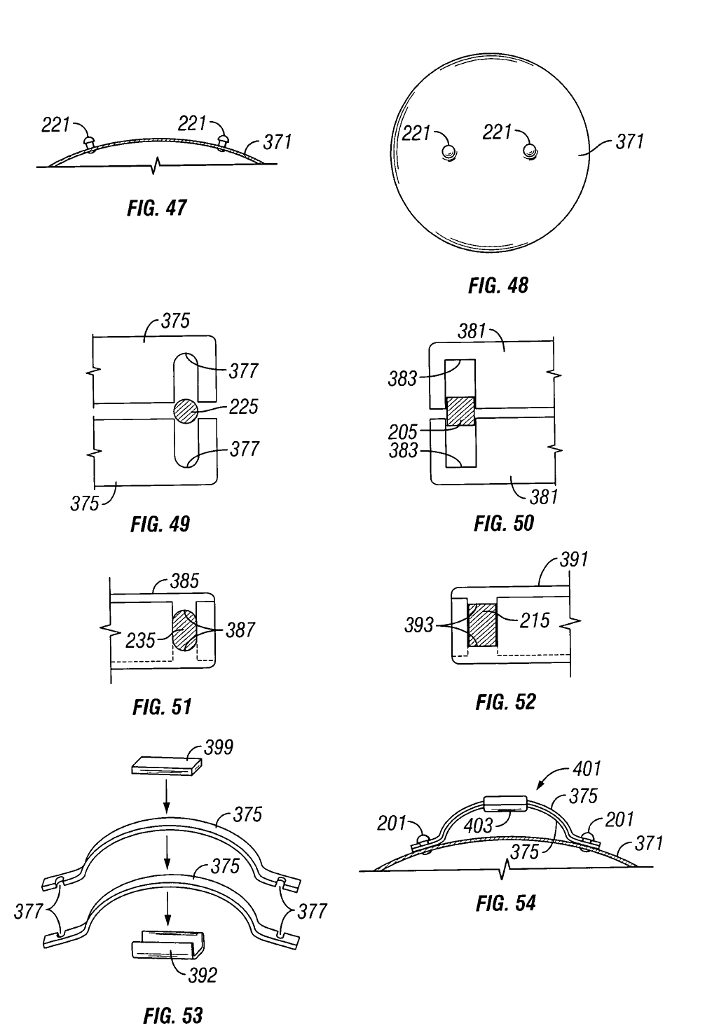

Stacking and storage can also be facilitated by the use of removable lid handles. A pot lid 371 has a pair of stand off rivets 201. FIG. 48 is a top view of the lid 371 of FIG. 47.

Referring to FIG. 49, a pair of opposing handle members 375 having rounded termination slots 377 lie on opposite sides of a cylindrical shaft 255. When the opposing handle members 375 pass one over the other in a manner which brings the slots 377 against the shaft 255, a stable configuration will be achieved so long as the handle members 375 are held together to continue to effectively capture the standoff rivets 221. Handle members 375 are preferably identical and can achieve the orientation of FIG. 49 by rotating one of them 1800 to a position where the slots 377 oppose each other.

Referring to FIG. 50, further variations are seen. FIG. 50 illustrates, a pair of opposing handle members 381 having square termination slots 383 which lie on opposite sides of a square shaft 205. When the opposing handle members 381 pass one over the other in a manner which brings the slots 383 against the shaft 205, a stable configuration will be achieved so long as the handle members 381 are held together to continue to effectively capture the standoff rivets 201.

Referring to FIG. 51, a pair of opposing handle members 385 having oval termination slots 387 lie atop each other on opposite sides of an oval shaft 235. The opposing handle members 385 lie one over the other in a manner which brings the slots 387 against the shaft 235, a stable configuration will continue so long as the handle members 385 are held together to continue to effectively capture the standoff rivets 231. Again, handle members 385 are preferably identical and can achieve the orientation of FIG. 51 by a 180° rotation.

Referring to FIG. 52, a pair of opposing handle members 391 having square termination slots 393 which lie on opposite sides of a rectangular shaft 215. As before, the opposing handle members 391 overlie each other in a manner which brings the slots 393 against the shaft 215.

Referring to FIG. 53, an exploded view of the handle assembly of FIG. 49 illustrates one way to hold the opposing handle members 375 together, by a tray 397 having a “C” cross sectional shape and an overlying plate or grip insert 399. The relationship between tray 397 and grip insert 399 can be plastic snap, or metal magnetic, including a plastic coated magnetic material.

Referring to FIG. 54, an assembled handle assembly 401 is secured by a grip assembly 403 atop a lid 371.

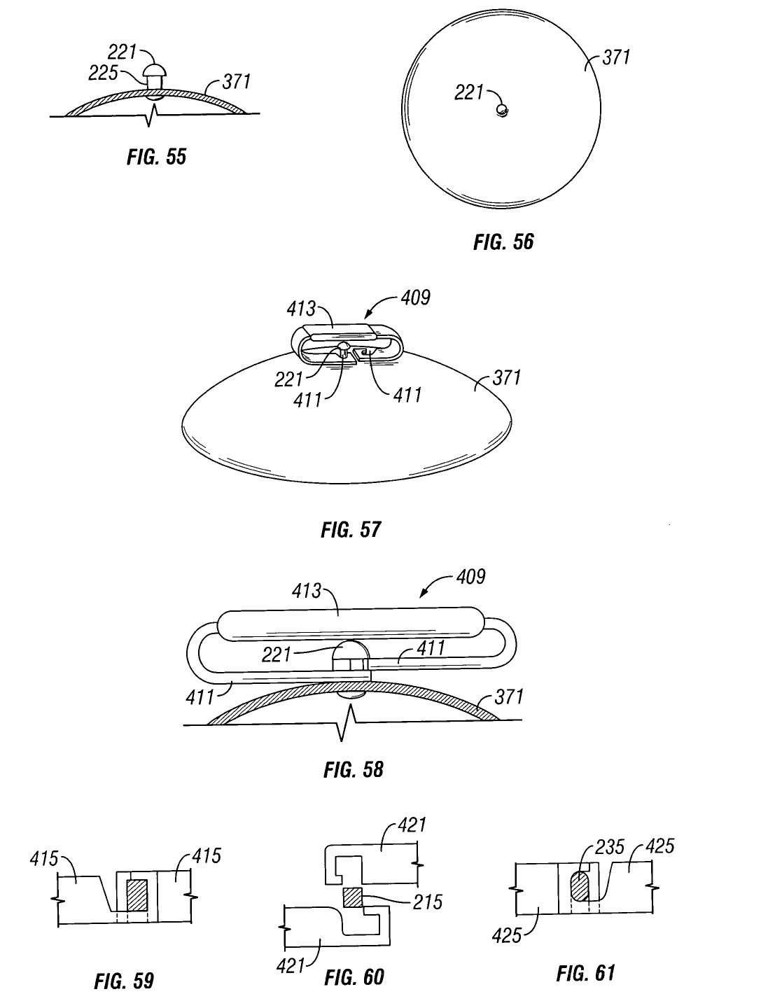

Referring to FIG. 55 a variation for lids 371 having a single, centrally located rivet 221 with a cylindrical shaft, for example, is shown. FIG. 56 is a top view of the complete lid 371 seen in FIG. 55. Referring to FIG. 57 an oval handle 409 with a pair of oppositely oriented overlapping hook members 411 are seen. The handle 409 has a grip portion 413.

Referring to FIG. 58, a closeup of the oval handle 409 is seen. The pair of oppositely oriented overlapping hook members 411 are seen oppositely engaging the shaft 225 of the rivet 221.

Referring to FIG. 59 a variation illustrating a pair of rectangular overlapping hook members 415 are seen engaging the rectangular cross shaped shaft 215 of a rivet 211 is seen. FIG. 60 illustrates a pair of square overlapping hook members 421 engaging the square cross shaped shaft 205 of rivet 201. FIG. 61 illustrates a pair of oval overlapping hook members 425 engaging the cross sectionally oval shaped shaft 235 of rivet 231.

While the present invention has been described in terms of devices and systems used to make handles removable for better shipping and storage, and in particular stackable storage of cooking structures, one of ordinary skill in the art can see that the device of the invention can be applied to many appliances and process tools. The present invention may be applied in any situation where handles and holding structures are desired to be removable.

Although the invention has been derived with reference to particular illustrative embodiments thereof, many changes and modifications of the invention may become apparent to those skilled in the art without departing from the spirit and scope of the invention. Therefore, included within the patent warranted hereon are all such changes and modifications as may reasonably and properly be included within the scope of this contribution to the art.

1. a handle for engaging a bracket supported by a cooking vessel comprising:
a handle body having a front wall having top side having pair of upwardly open slots and a bottom side, a rear wall having a bottom side connected to said bottom side of said front wall at an acute angle and a top side, and a horizontal member having a first end attached to said top side of said rear wall and a second end; and
a press-down plate supported by said horizontal member and extending over said top side of said front wall.

2. The handle as recited in claim 1 wherein said press-down plate is magnetically attracted to said horizontal member.

3. The handle as recited in claim 1 and further comprising a rounded clip attached to said second end of said horizontal member and engaging said press-down plate to facilitate holding said press-down plate onto said horizontal member.

4. The handle as recited in claim 3 wherein said front wall is curved.

5. The handle as recited in claim 1 wherein said horizontal member includes a pair of spaced apart side edges for guiding said press-down plate onto said horizontal member.

6. The handle as recited in claim 3 wherein said press-down plate has a curved portion adjacent said front wall.

7. The handle as recited in claim 1 and further comprising a slide on holder sleeve having an opening for accepting said second end of said horizontal member and a portion of said press-down plate, in a close relationship within said slide on holder sleeve.

8. A tong handle for engaging an engagement structure carried by a cooking vessel comprising:
a first tong shaped load member having a first end, a second end, and a first engagement plate at an angle with respect to said first end;
a second tong shaped load member having a first end, a second end, and a second engagement plate at an angle with respect to said first end;
means for controlling the position and force by which said first engagement plate is located with respect to said second engagement plate to secure said first and said second engagement plates to said engagement structure.

9. The tong handle as recited in claim 8 wherein said first and second engagement plates each carry one slot for engaging an associated rivet shaft and head as said engagement structures carried by said cooking vessel.

10. The tong handle as recited in claim 8 wherein said first and second engagement plates each carry a pair of slots for engaging an associated bracket as said engagement structures carried by said cooking vessel.

11. The tong handle as recited in claim 8 and further comprising a bracket having a pair of oppositely located footing members and curvature between said footing member forming three sides of a through hole upon mounting of said footing members to a cooking vessel.

12. The tong handle as recited in claim 8 wherein said means for controlling the position and force by which said first engagement plate is located with respect to said second engagement plate is a handle grip guide having a guide slot for interfitting with said first and second tong shaped load members; and
an overfitting cover member for enveloping and securing said guide slot with respect to said first and second tong shaped load members.

13. The tong handle as recited in claim 8 wherein said means for controlling the position and force by which said first engagement plate is located with respect to said second engagement plate is an engagement sleeve slot for receiving said first and second tong shaped load members; and
a slidable cover member for locking said first and second tong shaped load members within said engagement sleeve and wherein said engagement sleeve and said slidable cover member form a handle grip.

14. The tong handle as recited in claim 13 wherein said means for controlling the position and force by which said first engagement plate is located with respect to said second engagement plate is at least one of a tie brace and a linking brace.

15. A handle for engaging an engagement structure carried by a cooking vessel structure comprising:
a first load member having a first slot opening toward a first direction;
a second load member overlying and affixed with respect to said first load member and having a second slot opening toward a second direction generally opposing said first direction; said first and second slots surrounding and engagement structure for facilitating manipulation of said cooking vessel structure.
